(19) United States
(12) Patent Application Publication
(10) Pub. No.: US 2002/0129099 A1
(43) Pub. Date: Sep. 12, 2002

(54) Method and apparatus for virtualizing a serial port in a data processing system

(75) Inventors: Kevin Gene Kehne, Austin, TX (US); Kenneth Eugene Null, Round Rock, TX (US); Peter Adam Wendling, Poughkeepsie, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/801,607

(22) Filed: Mar. 8, 2001

(51) Int. Cl. G06F 15/16; G06F 9/00; G06F 15/173

(52) U.S. Cl. 709/203; 709/238; 709/225; 709/105

(57) ABSTRACT

A method, apparatus, and computer implemented instructions for redirecting a data stream within a data processing system. In response to detecting a request from a terminal, a signal is sent to a hardware switch to redirect the data stream from the first port to a processor. The data stream is packetized for transmission over a second port. The packetized data stream is sent by the processor to a destination over the second port.

### BACKGROUND OF THE INVENTION

1. Technical Field

The present invention relates generally to an improved data processing system, and in particular to a method and apparatus for handling data streams. Still more particularly, the present invention provides a method, apparatus, and computer implemented instructions for virtualizing a serial port.

2. Description of Related Art

A logical partitioning option (LPAR) within a data processing system (platform) allows multiple copies of a single operating system (OS) or multiple heterogeneous operating systems to be simultaneously run on a single data processing system platform. A partition, within which an operating system image runs, is assigned a non-overlapping sub-set of the platform's resources. These platform allocable resources include one or more architecturally distinct processors with their interrupt management area, regions of system memory, and I/O adapter bus slots. The partition's resources are represented by its own open firmware device tree to the OS image.

The configuration of these different partitions are typically managed through a terminal, such as a hardware system console (HSC). This HSC is typically connected to the data processing system through a serial port within the data processing system. Many of the software application involving system management, system debug, or system reboot are hardcoded to use the first serial port of the system as a standard input/output device. These serial ports typically follow Recommended Standard-232 (RS-232), which is a TIA/EIA standard for serial transmission between computers and peripheral devices, such as a modem, mouse, or a serial port. A RS-232 port uses a 25-pin DB-25 or 9-pin DB-9 connector.

As a result, the HSC requires a dedicated RS-232 cable for connection to the data processing system to obtain output from these applications and programs. Such an architecture reduces the distance from which an HSC may be located from the data processing system. Such a constraint is undesirable.

Therefore, it would be advantageous to have an improved method, apparatus, and computer implemented instructions for receiving data from applications and programs using a dedicated port.

### SUMMARY OF THE INVENTION

The present invention provides a method, apparatus, and computer implemented instructions for redirecting a data stream within a data processing system. In response to detecting a request from a terminal, a signal is sent to a hardware switch to redirect the data stream from the first port to a processor. The data stream is packetized for transmission over a second port. The packetized data stream is sent by the processor to a destination over the second port.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram of a data processing system in accordance with the present invention;

FIG. 3 is a block diagram of a data processing system, which may be implemented as a logically partitioned server;

FIG. 4 is a diagram illustrating a mechanism for virtualizing a serial port in accordance with a preferred embodiment of the present invention; and

FIG. 5 is a diagram illustrating states used in virtualizing a port in accordance with a preferred embodiment of the present invention.

### DETAILED DESCRIPTION OF THE PREFERRED EMBODIMENT

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to hardware system console 150. Server 104 is also connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 is a logically partitioned platform and provides data, such as boot files, operating system images and applications, to clients 108-112. Hardware system console (HSC) 150 may be a laptop computer and is used to display messages to an operator from each operating system image running on server 104, as well as to send input information, received from the operator, to server 104. In this example HSC 150 is connected to server 104 by a serial port.

Clients 108, 110 and 112 are clients to server 104. One of these clients, such as client 108 may be implemented as an HSC in additional to HSC 150. This implementation may be aided by the mechanism of the present invention to virtualize a serial port that might normally be a default port for applications that may be accessed by an HSC. The mechanism of the present invention activates a switch to redirect the data flow from the serial port, for formatting into a format transfer over network 102 to client 108. In these examples, the data stream is packetized to form a set of packets that are transferred to client 108.

Distributed data processing system 100 may include additional servers, clients, and other devices not shown. Distributed data processing system 100 also includes printers 114, 116 and 118. A client, such as client 110, may print directly to printer 114. Clients, such as client 108 and client 112, do not have directly attached printers. These clients may print to printer 116, which is attached to server 104, or to printer 118, which is a network printer that does not require connection to a computer for printing documents.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks, such as, for example, an intranet or a local area network.

FIG. 1 is intended as an example and not as an architectural limitation for the processes of the present invention.

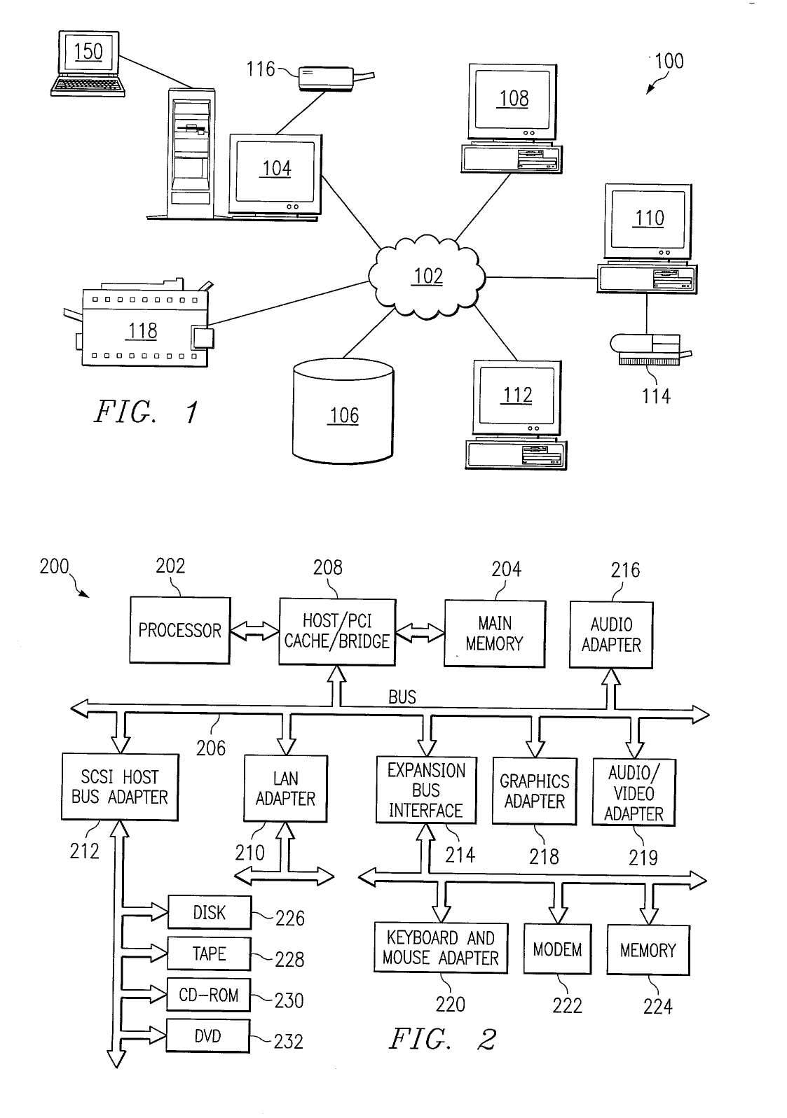

With reference now to FIG. 2, a block diagram of a data processing system in accordance with the present invention is illustrated. Data processing system 200 is an example of a client or a hardware system console, such as hardware system console 150 depicted in FIG. 1.

Data processing system 200 employs a peripheral component interconnect (PCI) local bus architecture. Although the depicted example employs a PCI bus, other bus architectures, such as Micro Channel and ISA, may be used. Processor 202 and main memory 204 are connected to PCI local bus 206 through PCI bridge 208. PCI bridge 208 may also include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter (A/V) 219 are connected to PCI local bus 206 by add-in boards inserted into expansion slots. Expansion bus interface 214 provides a connection for a keyboard and mouse adapter 220, modem 222, and additional memory 224. In the depicted example, SCSI host bus adapter 212 provides a connection for hard disk drive 226, tape drive 228, CD-ROM drive 230, and digital video disc read only memory drive (DVD-ROM) 232. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system, such as OS/2, which is available from International Business Machines Corporation. “OS/2” is a trademark of International Business Machines Corporation. An object-oriented programming system, such as Java, may run in conjunction with the operating system, providing calls to the operating system from Java programs or applications executing on data processing system 200. Instructions for the operating system, the object-oriented operating system, and applications or programs are located on a storage device, such as hard disk drive 226, and may be loaded into main memory 204 for execution by processor 202.

Those of ordinary skill in the art will appreciate that the hardware in FIG. 2 may vary depending on the implementation. For example, other peripheral devices, such as optical disk drives and the like, may be used in addition to or in place of the hardware depicted in FIG. 2. The depicted example is not meant to imply architectural limitations with respect to the present invention. For example, the processes of the present invention may be applied to multiprocessor data processing systems.

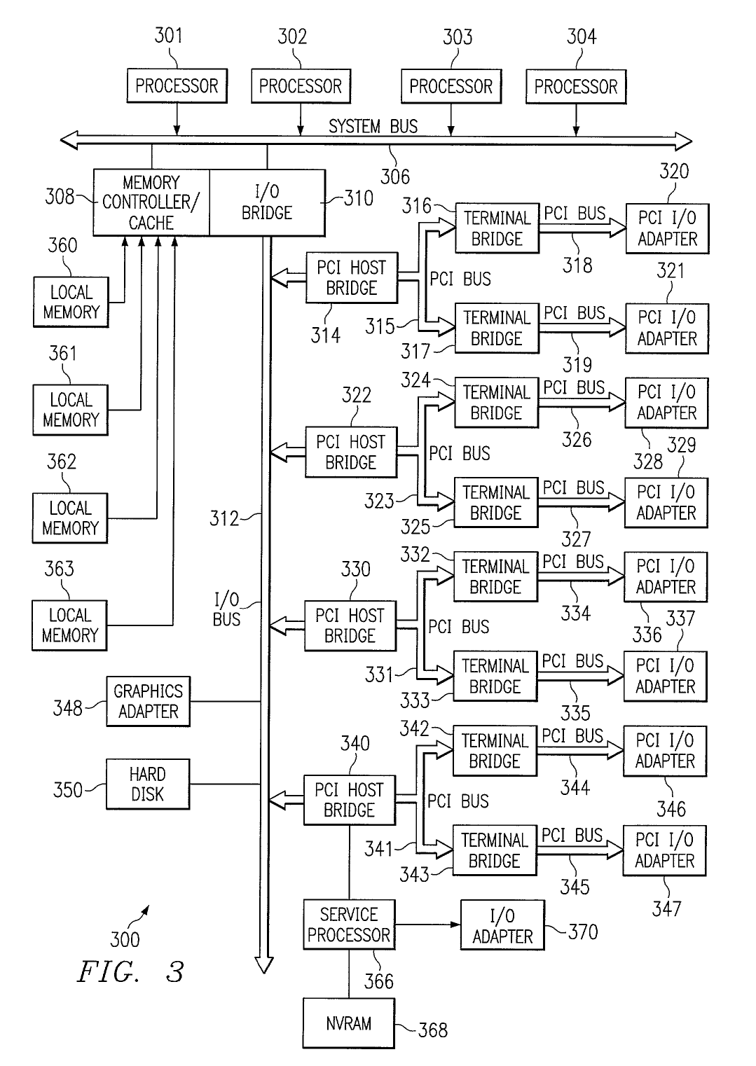

With reference now to FIG. 3, a block diagram of a data processing system, which may be implemented as a logically partitioned server, such as server 104 in FIG. 1, is depicted in accordance with the present invention. Data processing system 300 may be a symmetric multiprocessor (SMP) system including a plurality of processors 301, 302, 303, and 304 connected to system bus 306. For example, data processing system 300 may be an IBM RS/6000, a product of International Business Machines Corporation in Armonk, New York. Alternatively, a single processor system may be employed. Also connected to system bus 306 is memory controller/cache 308, which provides an interface to a plurality of local memories 360-363. I/O bus bridge 310 is connected to system bus 306 and provides an interface to I/O bus 312. Memory controller/cache 308 and I/O bus bridge 310 may be integrated as depicted.

Data processing system 300 is a logically partitioned data processing system. Thus, data processing system 300 may have multiple heterogeneous operating systems (or multiple instances of a single operating system) running simultaneously. Each of these multiple operating systems may have any number of software programs executing within in it. Data processing system 300 is logically partitioned such that different I/O adapters 320-321, 328-329, 336-337, and 346-347 may be assigned to different logical partitions.

Peripheral component interconnect (PCI) Host bridge 314 connected to I/O bus 312 provides an interface to PCI local bus 315. A number of Terminal Bridges 316-317 may be connected to PCI bus 315. Typical PCI bus implementations will support four Terminal Bridges for providing expansion slots or add-in connectors. Each of Terminal Bridges 316-317 is connected to a PCI I/O adapter 320-321 through a PCI Bus 318-319. Each I/O adapter 320-321 provides an interface between data processing system 300 and input/output devices such as, for example, other network computers, which are clients to server 300. Only a single I/O adapter 320-321 may be connected to each terminal bridge 316-317.

Additional PCI host bridges 322, 330, and 340 provide interfaces for additional PCI buses 323, 331, and 341. Each of additional PCI buses 323, 331, and 341 are connected to a plurality of terminal bridges 324-325, 332-333, and 342-343, which are each connected to PCI I/O adapters 328-329, 336-337, and 346-347 by PCI buses 326-327, 334-335, and 344-345. Thus, additional I/O devices, such as, for example, modems or network adapters may be supported through each of PCI I/O adapters 328-329, 336-337, and 346-347. In this manner, server 300 allows connections to multiple network computers. A memory mapped graphics adapter 348 and hard disk 350 may also be connected to I/O bus 312 as depicted, either directly or indirectly.

Management of logical partitions is achieved through terminals, such as hardware system consoles (HSCs). This access is provided in these examples through service processor 366, nonvolatile random access memory (NVRAM) 368, and input/output (I/O) adapter 370. HSCs connect to service processor 366 through I/O adapter 370. In these examples, I/O adapter 370, may be, for example, a serial port or an Ethernet adapter.

The mechanism of the present invention allows for redirection of data streams from a serial port to another port, such as an Ethernet adapter. In these examples, service processor 366 controls a hardware switch to a default or standard I/O device, such as a serial port, to redirect the data stream to another port.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

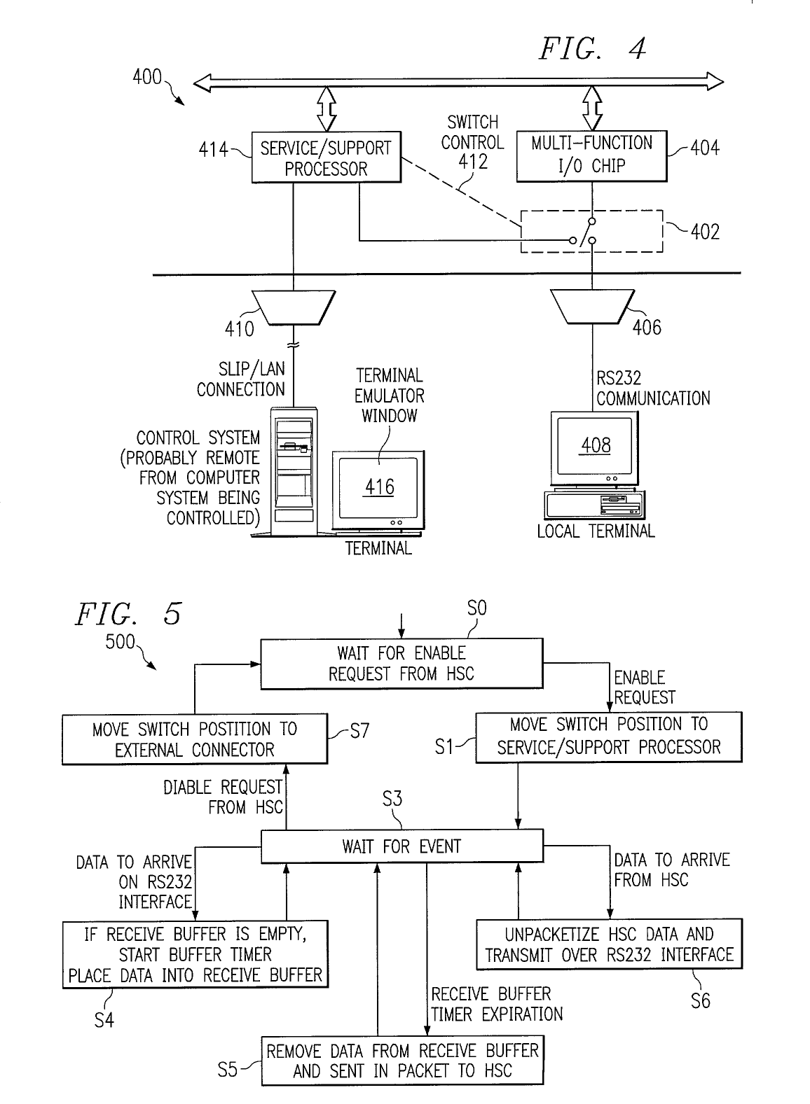

The present invention provides an improved method, apparatus, and computer implemented instructions for redirecting data streams from a default port to a desired port. Turning next to FIG. 4, a diagram illustrating a mechanism for virtualizing a serial port is depicted in accordance with a preferred embodiment of the present invention. For example, in data processing system 400, hardware switch 402 is placed between multifunction I/O function chip 404 and the default port, serial port 406. For many programs and applications, data can only be sent through serial port 406 to local terminal 408 using an RS-232 communications protocol.

The mechanism of the present invention allows for the default port to be virtualized and for the data to be sent through a desired port, such a port 410. A signal may be sent through line 412 to hardware switch 402 to redirect a data stream intended for output through serial port 406 to a service/support processor 414. Service/support processor 414 then takes the data stream and generates a set of packets from the data stream to form a packetized data stream. In these examples, the set of packets conform to standards used for sending data over Transmission Control Protocol/Internet Protocol (TCP/IP) networks. TCP/IP is a communications protocol used on the Internet and has become the global standard for communications. TCP provides transport functions, which ensure that the total amount of bytes sent is received correctly at the other end. The IP part of TCP/IP provides the routing capability. In a routable protocol, all messages contain not only the address of the destination station, but the address of a destination network. This address allows TCP/IP messages to be sent to multiple networks within an organization or around the world.

This packetized data stream may then be sent to remote terminal 416 through port 410, which is an Ethernet port to a LAN or serial line IP (SLIP). SLIP is a data link protocol for dial-up access to TCP/IP networks.

When the packetized data stream is received by remote terminal 416, the data is unpacketized and displayed. Further, packetized data streams may be received by service/support processor 414 from remote terminal 416 through port 410. This data stream is unpacketized and sent back to the program or application through hardware switch 402. In these examples, unpacketizing the data involves removing data from the packets and placing the data into the appropriate format for transmission to the destination, such as an application or a program.

Turning now to FIG. 5, a diagram illustrating states used in virtualizing a port is depicted in accordance with a preferred embodiment of the present invention. State machine 500 illustrates different states for a mechanism or program used to virtualize a port, such as a serial port. In the depicted examples, these states may be implemented as computer instructions executed by a processor, such as service processor 366 in FIG. 3 or service/support processor 414 in FIG. 4.

State machine 500 begins in state S0 by waiting for an enable request from an HSC. Upon receiving an enable request, state machine 500 shifts from state S0 to state S1 to change the switch position to direct data to the processor. The switch may be moved by sending a signal to the switch. Thereafter, state machine 500 shifts to state S3 to wait for an event. If data arrives from the RS-232 interface for the serial port, state machine 500 shifts to state S4 from state S3 and starts a buffer timer if the receive buffer is empty. Further, the data is placed into the receive buffer in state S4. Thereafter, state machine 500 shifts back to state S3. In state S3 if the buffer timer expires, state machine 500 shifts to state S5 and removes the data from the receive buffer, places the data into a packet, and sends the packet to the HSC. Afterwards, state machine 500 shifts back to state S3.

In state S3, if data is received from the HSC, state machine 500 shifts to state S6. The data is in a packetized format. In state S6, the data is unpacketized and transmitted over the RS-232 interface. State machine 500 then returns to state S3. If in state S3, a disable request is received from the HSC, state machine 500 shifts to state S7 and the switch is then moved to direct data to the external connector, which is the serial port in these examples. At this point, data is then directed through the serial port. Thereafter, state machine 500 returns to state S0 to await an enable request from the HSC.

In this manner, the mechanism of the present invention provides a method, apparatus, and computer implemented instructions for virtualizing a port, such as a serial port. Applications, which direct data to a default report, do not require modification to allow the data to be transmitted through another port. In the depicted examples, the serial port is virtualized to allow redirection of data intended for the serial port to be sent to another port, such as an Ethernet port. Further, no changes are required to the I/O chips. In these examples, the switch is placed between the I/O chip and the physical port itself.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for redirecting a data stream, the method comprising:
responsive to detecting a request from a terminal, sending a signal to a hardware switch to redirect the data stream from being sent through a first port to a processor;
packetizing the data stream for transmission over a second port to form a packetized data stream; and
sending the packetized data stream to a destination over the second port.

2. The method of claim 1, wherein the first port is a RS-232 standard port.

3. The method of claim 1, wherein the data stream is a RS-232 standard data stream.

4. The method of claim 1, wherein the packets are formed for transfer using a TCP/IP protocol.

5. The method of claim 1, wherein the second port provides a connection to a local area network.

6. The method of claim 1, wherein the data stream is an outgoing data stream further comprising:
receiving an incoming data stream, wherein the incoming data stream is packetized; and
unpacketizing the incoming data stream to form an unpacketized incoming data stream; and
sending the unpacketized incoming data stream to an input/output unit associated with the first port.

7. A method in a data processing system for redirecting a data stream normally sent to a default port, the method comprising:
receiving a request to send the data stream to a terminal communicating with the data processing system using a desired port;
sending a signal to a hardware switch to redirect the data stream to a service processor;
packetizing the data stream to form a set of data packets; and
sending the set of data packets to the terminal using the desired port.

8. The method of claim 7, wherein the set of data packets is a first set of data packets and further comprising:
receiving a second set of data packets form the terminal; and
unpacketizing the second set of data packets to from an unpacketized data stream; and
sending the unpacketized data stream to the hardware switch.

9. The method of claim 7, wherein the desired port provides a connection to a local area network.

10. The method of claim 7, wherein the terminal is a hardware system console.

11. A data processing system comprising:
a bus system;
a first communications unit connected to the bus system;
a second communications unit connected to the bus system;
a switch having a connection to the first communications unit, wherein the switch redirects a data stream intended for an output in the first communications unit to an alternate destination in response to a signal;
a memory connected to the bus system, wherein the memory includes as set of instructions; and
a processing unit connected to the bus system, wherein the processing unit executes the set of instructions to send a signal to the switch to redirect the data stream from the output of the first communications unit to the processor in response to detecting a request from a terminal; packetize the data stream to form a packetized data stream; and send the packetized data stream to a destination through the second communications unit.

12. The data processing system of claim 11, wherein the bus system is a single bus.

13. The data processing system of claim 11, wherein the bus system includes a primary bus and a secondary bus.

14. The data processing system of claim 11, wherein the processing unit includes a plurality of processors.

15. The data processing system of claim 11, wherein the second communications unit is one of a modem and Ethernet adapter.

16. The data processing system of claim 11, wherein the first communications unit is a RS-232 port.

17. A data processing system for redirecting a data stream, the data processing system comprising:
first sending means, responsive to detecting a request from a terminal, for sending a signal to a hardware switch to redirect the data stream from being sent through a first port to a processor;
packetizing means for packetizing the data stream for transmission over a second port to form a packetized data stream; and
second sending means for sending the packetized data stream to a destination over the second port.

18. The data processing system of claim 17, wherein the first port is a RS-232 standard port.

19. The data processing system of claim 17, wherein the data stream is a RS-232 standard data stream.

20. The data processing system of claim 17, wherein the packets are formed for transfer using a TCP/IP protocol.

21. The data processing system of claim 17, wherein the second port provides a connection to a local area network.

22. The data processing system of claim 17, wherein the data stream is an outgoing data stream further comprising:
receiving means for receiving an incoming data stream, wherein the incoming data stream is packetized; and
unpacketizing means for unpacketizing the incoming data stream to form an unpacketized incoming data stream; and
third sending means for sending the unpacketized incoming data stream to an input/output unit associated with the first port.

23. A data processing system for redirecting a data stream normally sent to a default port, the data processing system comprising:
receiving means for receiving a request to send the data stream to a terminal communicating with the data processing system using a desired port;
first sending means for sending a signal to a hardware switch to redirect the data stream to a service processor;
packetizing means for packetizing the data stream to form a set of data packets; and
second sending means for sending the set of data packets to the terminal using the desired port.

24. The data processing system of claim 23, wherein the set of data packets is a first set of data packets, the receiving means is a first receiving means, and further comprising:
second receiving means for receiving a second set of data packets from the terminal; and
unpacketizing means for unpacketizing the second set of data packets to form an unpacketized data stream; and
third sending means for sending the unpacketized data stream to the hardware switch.

25. The data processing system of claim 23, wherein the desired port provides a connection to a local area network.

26. The data processing system of claim 23, wherein the terminal is a hardware system console.

27. A computer program product in a computer readable medium for redirecting a data stream, the computer program product comprising:
first instructions, responsive to detecting a request from a terminal, for sending a signal to a hardware switch to redirect the data stream from being sent through a first port to a processor;
second instructions for packetizing the data stream for transmission over a second port to form a packetized data stream; and
third instructions for sending the packetized data stream to a destination over the second port.

28. The computer program product of claim 27, wherein the first port is a RS-232 standard port.

29. The computer program product of claim 27, wherein the data stream is a RS-232 standard data stream.

30. The computer program product of claim 27, wherein the packets are formed for transfer using a TCP/IP protocol.

31. The computer program product of claim 27, wherein the second port provides a connection to a local area network.

32. The computer program product of claim 27, wherein the data stream is an outgoing data stream further comprising:
fourth instructions for receiving an incoming data stream, wherein the incoming data stream is packetized; and
fifth instructions for unpacketizing the incoming data stream to form an unpacketized incoming data stream; and
sixth instructions for sending the unpacketized incoming data stream to an input/output unit associated with the first port.

33. A computer program product in a computer readable medium for redirecting a data stream normally sent to a default port, the computer program product comprising:
first instructions for receiving a request to send the data stream to a terminal communicating with the data processing system using a desired port;
second instructions for sending a signal to a hardware switch to redirect the data stream to a service processor;
third instructions for packetizing the data stream to form a set of data packets; and
fourth instructions for sending the set of data packets to the terminal using the desired port.

34. The computer program product of claim 33, wherein the set of data packets is a first set of data packets and further comprising:
fifth instructions for receiving a second set of data packets from the terminal; and
sixth instructions for unpacketizing the second set of data packets to form an unpacketized data stream; and
seventh instructions for sending the unpacketized data stream to the hardware switch.

35. The computer program product of claim 33, wherein the desired port provides a connection to a local area network.

36. The computer program product of claim 33, wherein the terminal is a hardware system console.
